(19) United States
(12) Patent Application Publication
(10) Pub. No.: US 2025/0197591 A1
(43) Pub. Date: Jun. 19, 2025

(54) PROCESS FOR THE DEPOLYMERIZATION OF PLASTIC WASTE MATERIAL

(71) Applicant: Basell Poliolefine Italia S.r.l., Milano (IT)

(72) Inventors: Nicolò Arich De Finetti, Ferrara (IT); Pietro Baita, Ferrara (IT); Diego Brita, Ferrara (IT); Ivano Capolungo, Ferrara (IT); Lorella Marturano, Ferrara (IT); Giulia Mei, Ferrara (IT)

(73) Assignee: Basell Poliolefine Italia S.r.l., Milano (IT)

(21) Appl. No.: 18/876,024

(22) PCT Filed: Jun. 14, 2023
(86) PCT No.: PCT/EP2023/065944

§ 371 Date: Dec. 17, 2024

(30) Foreign Application Priority Data
Jun. 21, 2022 (EP) 22180197.0

(51) Int. Cl. C08J 11/12

(52) U.S. Cl. CPC C08J 11/12; C08J 2300/30

(57) ABSTRACT

A process for depolymerizing waste plastic material and producing a pyrolytic oil, using a recycling circuit having a centrifugal pump and a shell and tube heat exchanger.

### FIELD OF THE INVENTION

In general, the present disclosure relates to the field of chemistry. More specifically, the present disclosure relates to polymer chemistry. In particular, the present disclosure relates to a process for the depolymerization of plastic waste material.

### BACKGROUND OF THE INVENTION

In an attempt to mitigate the impact of plastic waste material on the environment, plastic materials coming from domestic and industrial waste are recycled and, in part, reintroduced into the production cycle. In some instances, recycling of plastic waste material reduces the use of fossil hydrocarbon sources for producing plastic items.

However and in some instances, mechanical recycling of plastic materials produces substances with lower quality, is costly and burdensome, and is not applicable to waste when the plastic is mixed with different materials.

In some instances and as a consequence, some plastic waste is used as a source of thermal energy in plants such as incinerators or disposed in landfills.

As used herein, the term “thermocatalysis” refers to a process for converting plastic waste material to liquid fuel (pyrolytic product) by thermal, and optionally catalytic, degradation in the absence of oxygen. In some instances, the plastic waste is first melted within a stainless steel chamber under an inert purging gas, such as nitrogen. Then, in the same or a different chamber, further heat, and optionally a catalyst, is provided to crack the polymer molecules of the molten material to a gaseous state, thereby forming short hydrocarbon chains.

The resulting hot pyrolytic gases are then condensed in one or more condensers, thereby yielding a hydrocarbon distillate made from or containing straight and branched chain aliphatic, cyclic aliphatic, and aromatic hydrocarbons (pyrolytic oil).

In some instances, the depolymerization technique has the challenge of supplying heat to the molecules of the plastics material. It is believed that the challenges arise from plastics melt exhibiting high viscosity and plastics being poor heat conductors.

### SUMMARY OF THE INVENTION

In a general embodiment, the present disclosure provides a process for depolymerizing waste plastic material and producing a pyrolytic product, including the steps of:
(a) feeding a mixture made from or containing waste plastic material into a feeding system, including a screw extruder, and melting the plastic material, thereby forming a molten plastic material;
(b) removing the molten plastic material from the extruder and feeding the molten plastic material into a depolymerization reactor, being a continuously stirred tank reactor maintained at a temperature ranging from 280 to 600° C. and operated under a pressure ranging from 2.0 to 10 barg, thereby depolymerizing the plastic material and forming a gaseous effluent and a liquid effluent;
(c) directing a portion of the liquid effluent to a char handling section and feeding the gaseous effluent to a condensation unit;
(d) withdrawing a part of the liquid effluent and recirculating the part back to the depolymerization reactor via a recycling circuit, including a centrifugal pump and a shell and tube heat exchanger;
wherein the heat exchanger provides at least 80% of the heat demand of step (b).

### BRIEF DESCRIPTION OF DRAWINGS

FIG. 1 shows a schematic of a thermocatalytic process plant.

### DETAILED DESCRIPTION OF THE INVENTION

In some embodiments, the process is carried out in a continuous mode.

In stage (a), a charging system allows charging waste plastic materials to be fed into the depolymerization reactor (2). In some embodiments, the charging occurs in continuous mode. In some embodiments, care is taken for not introducing oxygen containing atmosphere into the system. In some embodiments, the barrier to the potentially oxygen-containing atmosphere is obtained by nitrogen blanketing or a vacuum system connected to a barrel of the extruder.

In some embodiments, the plastic waste mixture is charged into the feeding system of the depolymerization reactor (2) by a hopper or two or more hoppers in parallel. In some embodiments, the oxygen present in the atmosphere of the plastic waste material is displaced by nitrogen purge.

In some embodiments, the plastic waste mixture is made from or containing heterogeneous mixtures of waste plastic materials, wherein the greater portion of the waste plastics material are polyolefins. In some embodiments, the pyrolytic product is recirculated back to a cracking/refining unit, wherein the plastic waste mixture is made from or containing a polyolefin (PE and PP) content in an amount equal to or higher than 70% wt, based upon the total weight of the plastic waste mixture.

In some embodiments, the waste plastic material undergoes a pre-treatment stage, wherein the waste plastic material is melted by heat. In some embodiments, the waste plastic material undergoes a pre-treatment stage, wherein the waste plastic material is mixed with an additive. In some embodiments, the additive is an alkaline material. In some embodiments, the melting pre-treatment transforms a non-uniform mixture of different kinds of waste plastics into a mass of uniform plastic composite. In some embodiments, the melting pre-treatment occurs when the pyrolytic decomposition is performed without additives.

In some embodiments, the heating temperature in the pre-treatment stage is set to a temperature based on the kind and content of the plastic contained in the waste plastic material such that pyrolytic decomposition of the plastic material to be treated is inhibited. In some embodiments, the temperature is within a range of 100° C. to 300° C., alternatively 150° C. to 250° C. In some embodiments, the waste plastic material is made from or containing PVC resin. In some embodiments, a temperature close to 300° C. or more eliminates HCl from PVC resin.

In some embodiments, the HCl forming gas is (a) removed via a venting system and successively neutralized or (b) trapped if the waste plastic material is mixed with an alkaline material during the melting/kneading pre-treatment. In some embodiments, the melting operation uses kneaders or extruders with a screw. In some embodiments, the plastic waste is fed to the depolymerization reactor by an extruder.

In some embodiments, the extruder melts the plastic waste material, brings the plastic waste material to a temperature in the range of 250-350° C., and injects the molten plastic waste material into the depolymerization reactor (2). In some embodiments, the extruder receives the plastic waste material cut in small pieces into the feed hopper, conveys the stream in the melting section, and heats the plastic waste material by combined action of mixing energy and heat supplied by barrel heaters.

In some embodiments, additives are incorporated in the melt, thereby reducing corrosivity of the plastic waste material or improving pyrolytic products yield in the reaction section.

In some embodiments and during the extrusion, one or more degassing steps remove residual humidity.

In some embodiments and before being fed to the depolymerization reactor (2), the melt stream is filtered, thereby removing solid impurities.

In some embodiments, self-cleaning melt filters are operated for long time (several days) without manual intervention to replace filtration elements.

In some embodiments, the melt filter is based on a circular perforated plate as melt filtration element, holes by laser or by machining according to openings, where solid contaminant are accumulated. In some embodiments, an accumulation of impurities increases differential pressure across the melt filter. In some embodiments and for inline cleaning of the filtration element, a rotating scraper removes the accumulated impurities and guides the impurities to a discharge port. In some embodiments, the discharged port is opened for a period of time to purge contaminated material.

In some embodiments, this cycle is repeated several times (up to operation time of several days) without manual intervention or stopping production to replace the filtration element.

In some embodiments, the self-cleaning melt filter is based on the application of continuous filtering metal bands through which polymer flows. In some embodiments, impurities are accumulated on the metal filter, thereby generating increases of pressure. Accordingly, the clogged filtering band section is pushed out of the polymer passage area and a clean section is then inserted.

In some embodiments, this process is automatic, thereby allowing the process to operate for long time (up to several days) without manual intervention or stopping production, to replace the filtration element.

In some embodiments, the extrusion systems are selected from the group consisting of single screw extruders, twin screw extruders, and twin screw extruders with gear pump.

In some embodiments and in step (b), the depolymerization reactor (2) is an agitated vessel operated at a temperature ranging from 300 to 550, alternatively from 350 to 500° C.

In some embodiments, the operative pressure is in the range 2.5 to 8 barg, alternatively 3.0 to 7 barg.

In some embodiments, the melt viscosity of the reactor content permits homogeneously mixing by the stirring device. In some embodiments, the melt viscosity, measured at a temperature of 400° C., ranges from 0.1 to 250 cP, alternatively from 1 to 100 cP, alternatively from 5 to 50 cP.

In some embodiments, the melt viscosity is achieved in the absence of a viscosity decreasing agent.

In some embodiments, the molten mass of waste plastics entering the reactor is premixed with hydrocarbon oil, alternatively recirculated oil coming from the condensation unit, thereby promoting melt dissolution into the depolymerization reactor. In some embodiments, the premixing occurs in a dedicated vessel. In some embodiments, the volumetric ratio oil/molten mass ranges from 0.1:1 to 1:1.

In some embodiments, the depolymerization reactor (2) has a cylindrical section. In some embodiments, the cylindrical section has a rounded bottom. In some embodiments, the bottom of the reactor has a conical or truncated conical shape.

In some embodiments, the depolymerization reactor (2) has a mixer installed in the vertical axis of the reactor, with a gear motor for rotating the blades of the mixer and thereby maintaining the system in stirred state. In some embodiments, the design of the mixer and the power of the motor vary in respect of the reactor content, volume, and shape. In some embodiments, the reactor operates with a power input ranging from 0.2 to 4 kW/m³, alternatively 0.2-2 kW/m³, alternatively from 0.3 to 1.5 kW/m³.

In some embodiments, the shell and tube heat exchanger (5) provides at least 80%, alternatively more than 85%, alternatively more than 90%, of the total heat demand of the step (b). In some embodiments, the heat provided to the reactor content by the reactor walls is less than 10%, alternatively less than 5%, alternatively absent. In some embodiments, the depolymerization reactor (2) is free of jacketed walls for heating the reactor content. In some embodiments, the reactor is jacketed. In some embodiments, no heating fluid circulates in the reactor jacket.

In some embodiments, a heat transfer fluid, which is operable at the depolymerization temperature or above, provides heat to the external heat exchanger (5). In some embodiments, the heat transfer fluid is a solar salt or synthetic oil. In some embodiments, the heat transfer fluid is a molten solar salt heated to a temperature ranging from 300° C. to 570° C.

In some embodiments, the heat is exchanged via the shell and tube heat exchanger (5) by the liquid effluent from the depolymerization reactor (2) flowing inside the tubes of the heat exchanger while the heat transfer fluid flows on the process side in the shell.

In some embodiments, the feeding circuit (not shown) of the molten salt is constructed to prevent molten salt leakage. In some embodiments, the molten salt is molten solar salt. In some embodiments, the molten solar salt is a mixture of sodium nitrate and potassium nitrate. In some embodiments, the sodium nitrate and potassium nitrate are in a weight ratio ranging from 2:3 to 3:2. In some embodiments, the solar salt receives heat from a dedicated furnace. In some embodiments, the furnace is electric or fed with fuel. In some embodiments, the furnace is electric. In some embodiments, the electricity comes from renewable sources. In some embodiments and for the fuel-based furnace, part of the recovered oil from the condensation unit (3) feeds the furnace.

In some embodiments, the heat transfer fluid is circulated into the heat exchanger by the use of a circulation pump. In some embodiments, the heat transfer fluid is a molten salt.

In some embodiments, shell and tube heat exchanger is a single shell/single tube pass heat exchanger.

In some embodiments, the process uses two shell and tube heat exchangers configured either in series or in parallel.

In some embodiments and within the tubes of the heat exchanger, the slurry flows with a velocity ranging from 3-10 m/sec, alternatively 5-8 m/sec. It is believed that velocities lower than 2 m/sec may cause slurry sedimentation.

The liquid effluent, which is a slurry of solid materials dispersed in a liquid hydrocarbon medium, is recirculated by centrifugal pump (4).

In some embodiments, chunks or other solid residues are present in the liquid effluent. In some embodiments and without being bound by any theory, the impeller of the centrifugal pump crushes the char chunks into powder.

In some embodiments, a coke crusher is installed on the hub of the centrifugal pump shaft.

In some embodiments, the portion of the liquid slurry recirculated to the reactor is withdrawn from a point of the reactor different from the point of the withdrawal of the liquid slurry portion sent to the char handling.

In some embodiments, both the liquid slurry portion recirculated to the reactor and the liquid slurry portion sent to the char handling are withdrawn from the same point and then successively split.

In some embodiments, the split between the portion of liquid slurry directed to char handling and the portion recirculated to the depolymerization reactor takes place before or after the centrifugal pump (4). In some embodiments, the liquid slurry is first fed to a dedicated vessel equipped with a lower and upper exit point. In some embodiments, the liquid portion directed to char handling (6) is withdrawn in a concentrated form from the lower exit point while the liquid portion to be recycled to the reactor (2) is withdrawn from the upper exit point.

In some embodiments, the depolymerization process taking place within the reactor produces molecules, having reduced chain length and low boiling point. In some embodiments, this continuously running chain breakage mechanism produces molecules increasingly smaller part. In some embodiments, the chain breakage mechanism occurs close to the reactor walls. At the operating temperature and pressure, part of the resulting molecules is gaseous.

In some embodiments, the resulting composition within the reactor is made from or containing a range of hydrocarbons from methane to heavier products, both saturated and olefinic, with linear or highly branched structures. In some embodiments, the resulting composition is made from or containing aromatic molecules or molecules having fused rings structures.

In some embodiments, a part of the resulting molecules is liquid at the operating conditions and contributes to lowering the liquid mass viscosity. In some embodiments, the content of the depolymerization reactor (2) is made from or containing a liquid slurry phase, wherein solid and inorganic substances are dispersed in a liquid hydrocarbon medium, and a gaseous phase. In some embodiments, the solid substances are carbonaceous substances.

In some embodiments, part of the liquid slurry phase is withdrawn from the reactor and constitutes the liquid effluent, which is sent to the char handling section (6). In some embodiments, the part of the liquid slurry phase is withdrawn from the lower part of the depolymerization reactor.

In some embodiments, the withdrawal of the slurry phase from the bottom of the reactor is triggered by density sensors detecting the density of the liquid slurry reaching a predetermined value.

The gaseous phase of the depolymerization reactor (2) constitutes the gaseous effluent, which is sent to the condensation unit (3) for further treatment.

In some embodiments, the gaseous effluent is made from or containing a mixture of light hydrocarbons. In some embodiments, the mixture of light hydrocarbons has heavy hydrocarbons and char particles entrained. In some embodiments, the gaseous effluent is conveyed from the reactor top to the condensation unit (3). In some embodiments, the condensation unit (3) is operated at a pressure lower than the pressure of the depolymerization reactor (2).

In some embodiments, the condensation unit (3) is a scrubber column, thereby suppressing the entrained char. In some embodiments, the condenser temperature is selected such that the heavy hydrocarbons are condensed and the light hydrocarbons are released as gaseous stream. In some embodiments, the gaseous stream (H₂ and light hydrocarbons) is conveyed to a second condensation unit (not shown). In some embodiments, the second condensation unit is working at a temperature lower than the condensation unit (3), from which oil is recovered.

In some embodiments, the operative temperature of the condensation unit (3) varies and depends on the operative pressure. In some embodiments and with atmospheric pressure, the operating temperature is from 20° C. to 200° C., alternatively from 40 to 100° C., alternatively from 50 to 90° C.

In some embodiments, the resulting liquid stream is made from or containing about 2 wt % or more of compounds with retention time equal to, or less than, n-heptane, about 25 wt % or more of compounds with retention time between n-heptane and n-dodecane, a larger fraction of compounds having a retention time higher than n-dodecane and lower than n-octacosane (70 wt % or less), and optionally, a small amount of a fraction with higher retention time.

In some embodiments, a dephlegmator (partial condenser) is installed on top of the scrubber and works at a temperature lower than the temperature inside the column. The condensate flows down as reflux for the scrubber by virtue of gravity. In some embodiments, the dephlegmator is installed as a separate piece of equipment or inside the scrubber.

In some embodiments, a pump recycles the liquid that collects in the bottom of the scrubber to the top of the column. The recycled liquid is cooled in a dedicated heat exchanger before injection into the scrubber top as reflux.

In some embodiments, the hydrocarbon condensate constitutes the liquid stream, which is sent to further processing or to a second depolymerization reactor. In some embodiments, the hydrocarbon condensate has more than C7 carbon atoms.

In some embodiments, a second depolymerization reactor is present. In some embodiments, the second depolymerization reactor is the same type as the depolymerization reactor (2). In some embodiments, the second depolymerization reactor is a continuously stirred tank reactor equipped with the same recycling circuit which, by virtue of centrifugal pump and shell and tube heat exchanger, provides heat to the depolymerization stage.

In some embodiments, the second depolymerization reactor is connected in series (sequential) or in parallel to the depolymerization reactor (2). In some embodiments, the setup is sequential.

In some embodiments, one or more depolymerization reactors are equipped with one or more additional recycling circuits, each of which provided with centrifugal pump and heat exchanger.

In some embodiments, the depolymerization takes place in the same range of temperatures. In some embodiments and to limit the volatility of the heavy hydrocarbons, the second depolymerization reactor is operated at a pressure higher than depolymerization reactor (2), alternatively in the range from 3 to 10 barg, alternatively from 3 to 9 barg, alternatively from 3 to 8 barg.

In some embodiments, the depolymerization step (b) takes place in the presence of a catalyst. In some embodiments, the catalyst is a depolymerization/cracking catalyst for thermocatalytic processes. In some embodiments, the catalyst is selected from the group consisting of metal oxides, heteropolyacids, mesoporous silica, and aluminosilicates catalysts. In some embodiments, the catalyst is selected from the group consisting of halloysite, kaolinite, and zeolites. In some embodiments, the zeolites are selected from the group consisting of synthetic Y-type zeolite and ZSM-5.

In some embodiments, the amount of catalyst feed is not more than 10% wt, alternatively not more than 5% wt, alternatively not more than 2% wt, with respect to the plastic waste feed.

In some embodiments, the catalyst is injected into the depolymerization reactor (2) as powder dispersed into a hydrocarbon oil, alternatively the liquid pyrolytic product (oil) obtained from condensation unit (3).

In some embodiments, the catalyst slurry is prepared in a pot, being a continuously stirred vessel, where the catalyst is poured from a dedicated silo to keep constant the concentration of the catalyst in the slurry.

In some embodiments, the pyrolytic oil dispersing the catalyst is withdrawn from the condensation unit (3 to keep constant the slurry level in the pot. In some embodiments, the catalyst slurry is injected. In some embodiments, the catalyst slurry is injected by a progressive cavity pump thereby maintaining the catalyst slurry's level constant.

In some embodiments, the liquid effluent coming from depolymerization reactor (2) is a concentrated hydrocarbon slurry. In some embodiments, the concentrated hydrocarbon slurry contains the depolymerization catalyst.

In some embodiments, the catalyst is fed in the plastic waste feedstock pre-treatment stage. In some embodiments, the catalyst is added to the extruder and, therein, mixed with the molten feedstock.

In some embodiments, a second depolymerization reactor is present and a gaseous effluent is conveyed from the second depolymerization reactor to a second condensation unit for recovering the pyrolytic product in the form of an oil.

In some embodiments, the second condensation unit has a similar configuration to condensation unit (3). In some embodiments, the second condensation unit has a lower operating temperature and pressure than condensation unit (3).

In some embodiments, the operating temperature of the second condensation unit ranges from 20 to 80° C., alternatively from 30 to 70° C. In some embodiments, the operating pressure of the second condensation unit is lower than the operating pressure of condensation unit (3), thereby allowing incondensable gases from condensation unit (3) to enter second condensation unit without further pressurization. In some embodiments, the oil recovered from the second condensation unit is lighter than the oil recovered from condensation unit (3). In some embodiments, the oil recovered from the second condensation unit has the following composition (GC determined):
about 10-15% wt % of a fraction having a retention time equal or less than n-heptane;
about 70-75 wt % of a fraction having a retention time between n-heptane and n-dodecane,
about 12-20 wt % of a fraction having a retention time between n-dodecane and n-octacosane, and
no traces of compounds having a higher retention time than n-octacosane.

In some embodiments, the liquid effluent discharged from the depolymerization reactor (2) and directed to the char handling section is in the form of slurry, alternatively concentrated slurry. In some embodiments, the liquid effluent is discharged continuously. It is believed that the pressure of a pressurized reactor permits the discharge of a concentrated slurry to a lower pressure device without using additional withdrawal equipment. In some embodiments, the slurry is discharged by the bottom of the reactor or from a line or vessel after the centrifugal pump (4).

In some embodiments, the flow of the slurry stream is continuous. In some embodiments, the char content in the slurry ranges from 10 to 65% wt, alternatively from 20 to 40% wt, based upon the total weight of the slurry.

In some embodiments, the char handling sections are described in co-pending Patent Cooperation Treaty Application Nos. PCT/EP2021/086926 and PCT/EP2021/086927, the relevant part of which is incorporated by reference.

In some embodiments, the char handling section (6) is operated at nearly atmospheric pressure and higher temperature (with respect to the pyrolizer), thereby promoting separation between char and volatiles.

In some embodiments, volatiles separated in the char handling section (6) are condensed and recycled back to the depolymerization reactor (2).

In some embodiments, the depolymerization process produces about 10% wt of pyrolytic gas, about 80% wt pyrolytic oil, and about 10% wt of char. In some embodiments, the coking and fouling phenomena associated to the reactor wall heating is reduced or eliminated.

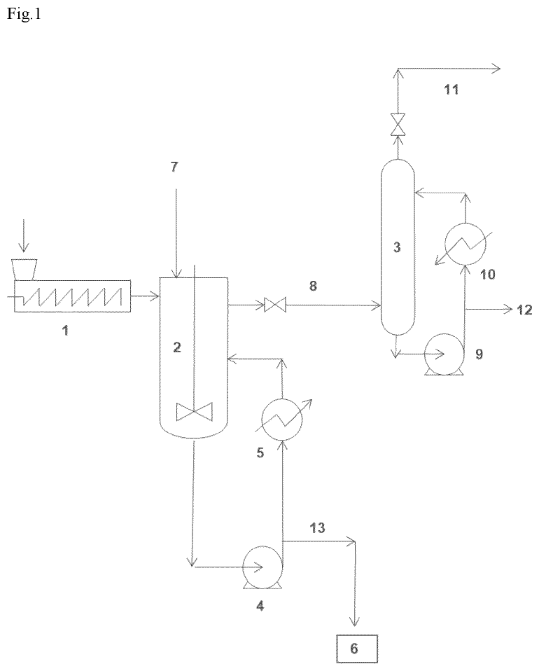

FIG. 1 shows a schematic a thermocatalytic process, wherein plastic waste is melted in extruder (1) and then supplied to depolymerization reactor (2). If used, a catalyst is supplied via inlet (7). The depolymerization reactor has a recycling circuit with centrifugal pump (4) and shell and tube heat exchanger (5). From the recycling circuit, the slurry is recycled via line (13). Gaseous effluents are collected at the reactor top and sent via line (8) to condensation unit (3). Condensation unit (3) has a recycling circuit for recycling the condensate via a circulation pump (9) flows through the heat exchanger (10) and to the condensation column (3). From the top of the column via line 11, gaseous product is collected and conveyed to further processing. From the line 12, pyrolytic oil is collected and conveyed to further processing or storage.

In some embodiments, the product of the pyrolytic process is a hydrocarbon feedstock partially replacing oil feedstock in cracking plants. In some embodiments, the product is fuel.

### EXAMPLES

### Example 1

The following experimental steps were carried out in a depolymerization apparatus, having a depolymerization reactor, consisting of a jacketed mechanically agitated vessel equipped with an inlet for the plastic waste coming from an extruder feed, an outlet for the generated gases, and an outlet for the char handling section. The gases withdrawn from the depolymerization reactor were conveyed to a condensation unit from which an incondensable gas and a pyrolytic oil were obtained.

Thermocouples were positioned in the depolymerization reactor to monitor and record temperatures.

The depolymerization reactor was also provided with a recycling circuit having a centrifugal pump and a shell and tube heat exchanger. Via the recycling circuit, part of the liquid slurry was withdrawn from the depolymerization reactor, sent to the heat exchanger, and reintroduced into the reactor.

The shell and tube heat exchanger was provided with a flow of molten solar salt flowing in the shell at a temperature of about 465° C. while no molten solar salt was provided to the reactor jacket.

The plastic waste feedstock was analyzed to check for polyolefin content (97 wt %) and residuals (traces of other polymers such as PET, PS, PA, and PU and inorganic contaminants).

The feedstock was homogenized and pelletized before loading the hopper. The extruder was operated at a temperature of 250° C., and the molten plastic material was discharged continuously into the depolymerization reactor at 7 kg/h. The depolymerization reactor was operated at a pressure of 4 barg and a temperature of about 410° C. while the average residence time was about 3 h. The gaseous phase of the depolymerization reactor was sent to a condensation unit formed by a cooling/scrubber column working at 50° C. and a dephlegmator working at 25° C.

Another portion of the liquid slurry was sent to the char handling section.

The process ran smoothly and continuously for 30 days without operative problems and no fouling was observed on the heat transfer surfaces during the subsequent inspection. These results were obtained without providing further heat to the reactor walls, without adding further oil to lower viscosity of reactor content, and without recurring to the reactor design described in U.S. Pat. No. 5,917,102. After 30 days of operation, the internal walls of the depolymerization reactor and other part of the reactor system showed no fouling coming from char sticking particles.

The condensed oil was analyzed via GC-FID. Due to the number of compounds, the results of the analysis are reported by grouping according to retention time and using specific hydrocarbons as internal retention time standards. Results are reported in Table 1.

### Comparative Example 1

A similar trial was carried out using the experimental setup described in example 1 but providing a flow of molten solar salt also to the reactor jacket. The same flow of molten solar salt was used in series both in the exchanger shell and the reactor jacket at a temperature of about 425° C.

With this setup, 70% of the heat demand was provided through the shell and tube heat exchanger.

The feedstock was homogenized and pelletized before loading the hopper. The extruder was operated at a temperature of 250° C., and the molten plastic material was discharged continuously into the depolymerization reactor at 9 kg/h. The depolymerization reactor was operated at a pressure of 4 barg and a temperature of about 410° C. while the average residence time was about 3 h. The gaseous phase of the depolymerization reactor was sent to a condensation unit formed by a cooling/scrubber column working at 50° C. and a dephlegmator working at 25° C.

After 10 days of operation, the internal walls of the jacketed reactor were fouled with char particles.

Results of oil characterization are reported in Table 1.

TABLE 1

| | | 98° C. < | 203° C. < | 365° C. < | |
|---|---|---|---|---|---|
| | BP < | BP < | BP < | BP < | BP > |
| Ex | 98° C. | 203° C. | 365° C. | 434° C. | 434° C. |
| Ex. 1 | 7 | 47 | 43 | 2 | 1 |
| Comp. | 7 | 53 | 36 | 3 | 1 |
| Ex. 1 | | | | | |

What is claimed is:

1. A process for depolymerizing waste plastic material and producing a pyrolytic product, comprising the steps of:
(a) feeding a mixture comprising waste plastic material, into a feeding system, comprising a screw extruder, and melting the plastic material, thereby forming a molten plastic material;
(b) removing the molten plastic material from the extruder and feeding the molten plastic material into a depolymerization reactor, being a continuously stirred tank reactor maintained at a temperature ranging from 280 to 600° C. and operated under a pressure ranging from 2.0 to 10 barg, thereby depolymerizing the plastic material and forming a gaseous effluent and a liquid effluent;
(c) directing a portion of the liquid effluent to a char handling section and feeding the gaseous effluent to a condensation unit;
(d) withdrawing a part of the liquid effluent and recirculating the part back to the depolymerization reactor via a recycling circuit comprising a centrifugal pump and a shell and tube heat exchanger;
wherein the heat exchanger provides at least 80% of the heat demand of step (b).

2. The process according to claim 1, wherein plastic waste material is a mixture of waste materials and the greater portion of the waste materials comprises polyolefins.

3. The process according to claim 1, wherein the depolymerization reactor is an agitated vessel operated at a temperature ranging from 300 to 550° C. and under a pressure in the range 2.5 to 8.0 barg.

4. The process according to claim 1, wherein the melt viscosity of the reactor content, measured at a temperature of 400° C., ranges from 0.1 to 250 cP.

5. The process according to claim 1, wherein the heat exchanger provides more than 85% of the heat demand of step (b).

6. The process according to claim 1, wherein a heat transfer fluid provides heat to the heat exchanger.

7. The process according to claim 6, wherein the heat transfer fluid is molten solar salt heated to a temperature ranging from 300° C. to 570° C.

8. The process according to claim 1, wherein liquid effluent from the depolymerization reactor flows inside the tubes of the heat exchanger while the heat transfer fluid flows on the process side in the shell.

9. The process according to claim 1, wherein the liquid effluent is withdrawn from the lower part of the depolymerization reactor.

10. The process according to claim 1, wherein the char content in the liquid effluent ranges from 10 to 65% wt, based upon the total weight of the slurry.

11. The process according to claim 1, wherein the pyrolytic product is recovered in the form of oil from the condensation unit and comprises:
about 10-15% wt % of a fraction having a retention time equal or less than n-heptane;
about 70-75 wt % of a fraction having a retention time between n-heptane and n-dodecane, and
about 12-20 wt % of a fraction having a retention time between n-dodecane and n-octacosane.

12. The process according to claim 1, wherein the pyrolytic product in form of oil is a hydrocarbon feedstock for cracking plants.

13. The process according to claim 1, wherein a coke crusher is installed on the hub of the centrifugal pump shaft.

14. The process according to claim 1, wherein the heat exchanger is a single shell pass/single tube pass heat exchanger.

15. A reactor configuration for depolymerizing waste plastic material comprising a depolymerization unit, which is a continuously stirred tank reactor, provided with an outlet for gaseous effluent, an outlet for a liquid slurry effluent, and a recycling circuit, for withdrawing and reintroducing liquid effluent to the depolymerization unit, comprising a recycling pipe connected to a centrifugal pump and a shell and tube heat exchanger.
